(19) United States
(12) Patent Application Publication
(10) Pub. No.: US 2011/0231387 A1
(43) Pub. Date: Sep. 22, 2011

(54) ENGAGING CONTENT PROVISION

(75) Inventors: Alpa Jain, San Jose, CA (US); Gilad Mishne, Oakland, CA (US)

(73) Assignee: YAHOO! INC., Sunnyvale, CA (US)

(21) Appl. No.: 12/729,028

(22) Filed: Mar. 22, 2010

(51) Int. Cl. G06F 17/30

(52) U.S. Cl. 707/709; 707/769; 707/748; 707/803; 707/E17.005; 707/E17.009; 707/E17.014; 707/E17.046; 707/E17.108

(57) ABSTRACT

A model is created and from seed trivia facts will create a database of pruned and ranked trivia facts and associated trigger terms. Search, email, or other information provider systems are configured to detect usage of the trigger terms and provide relevant trivia facts in response to the usage.

### BACKGROUND OF THE INVENTION

The present invention is generally related to search engines, systems, and methods.

Attracting and retaining users of web sites generally, including search engines, depends in part on quality of search results, ease of use, and the general user experience.

### SUMMARY OF THE INVENTION

Embodiments comprise a method and system for generating and providing entertaining, related content alongside search results, search suggestions, or content such as email and news pages.

A model is created that from seed trivia facts will create a database of pruned and ranked trivia facts and associated trigger terms. Search, email, or other content provider systems are configured to detect usage of the trigger terms and provide relevant trivia facts in response to the usage.

One aspect relates to a computer system for providing a service to a user. The computer system configured is to: generate seed trivia facts; extract features of the seed facts; train a supervised model to compute an interestingness score for candidate trivia facts; use the model to identify new candidate trivia facts; assign interestingness score to the candidate facts; rank the candidate trivia facts to create a selected set of trivia facts; and identify trigger terms for each trivia fact of the selected set.

Another aspect relates to a method for operating a search engine system. The method comprises: generating seed trivia facts; extracting features of the seed facts; training a supervised model to compute an interestingness score for candidate trivia facts; using the model to identify new candidate trivia facts; assigning interestingness score to the candidate facts; ranking the candidate trivia facts to create a selected set of trivia facts; identifying trigger terms for each trivia fact of the selected set; and creating a database comprising a plurality of trivia entries, each entry comprising: a trivia fact of the selected set; the interestingness score for the trivia fact; and one or more trigger terms for the trivia fact. A further aspect involves monitoring a query made of the computer system and determine if the query contains a trigger term of the one or more trigger terms contained in the database.

### BRIEF DESCRIPTION OF THE DRAWINGS

FIG. 1 is a flow chart illustrating the building of a trivia database which is then applied by a search engine or email system or other provider.

FIG. 2 illustrates a flow chart/architectural model according to an embodiment.

FIGS. 3A and 3B depict an application of the trivia database.

FIG. 3C is a simplified diagram of a computing environment in which embodiments of the invention may be implemented.

### DETAILED DESCRIPTION OF THE PREFERRED EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention. All documents referenced herein are hereby incorporated by reference in the entirety.

A computer system employs a model that is created and from seed trivia facts, creates a database of pruned and ranked trivia facts and associated trigger terms, and provides the facts when the trigger terms are detected. Embodiments generate seed sets to identify new candidates for trivia fact production. Such trivia fact product may be used in a number of scenarios, including as an enhancement to the search assistance layer of a search engine, or for placement on a search results page, or together with advertisements or email and news pages etc.

Actively engaging the user may increase click through and facilitate return usage and site loyalty, among other benefits.

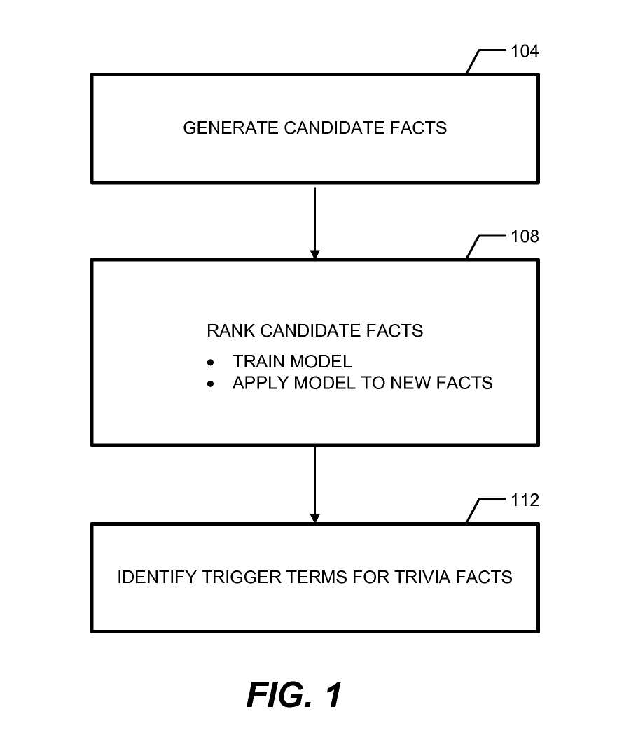

FIG. 1 is a flow chart illustrating the building of a trivia database which is then applied by a search engine or email system or other provider.

In step 104, embodiments generate candidate facts as an information extraction task and in some cases use bootstrapping extraction methods. In step 108 candidate facts are ranked. This involves, at a high level, training a model and the applying the model to new facts. In step 112, trigger terms for trivia facts are identified. These trigger terms are associated in the database with the produced trivia facts.

Embodiments treat the task of ranking candidate facts by their “interestingness” or “engagement” level as a semi-supervised learning task. That is, the system assumes a set of (e.g. preselected) seed trivia facts to be engaging ones, and collects an additional set of random facts (for example, from arbitrary encyclopedic entries) that are assumed to be not engaging.

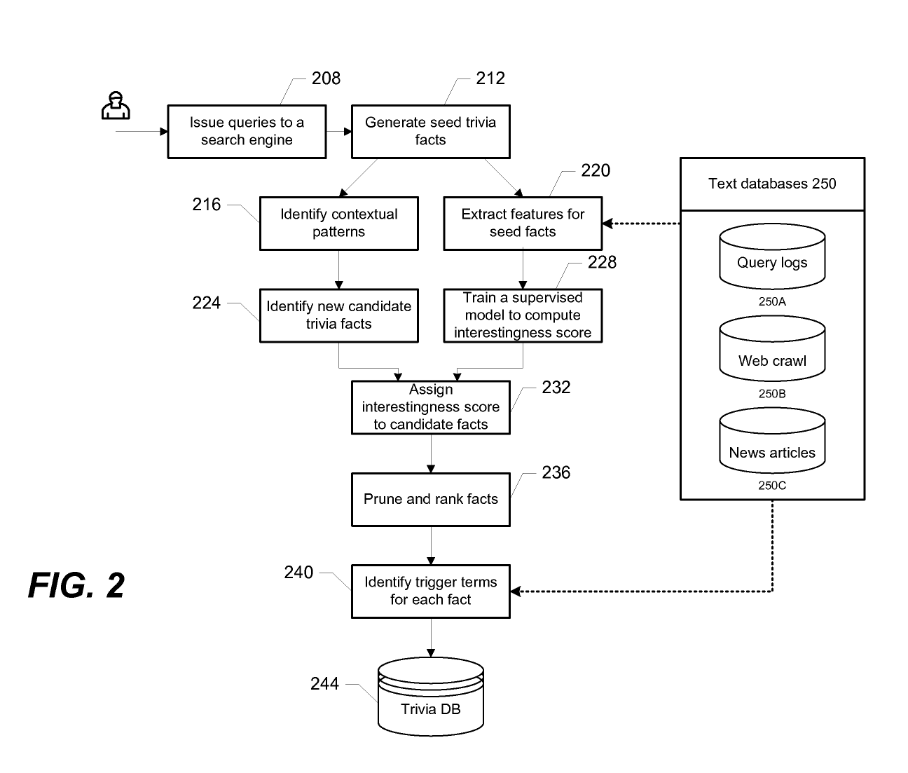

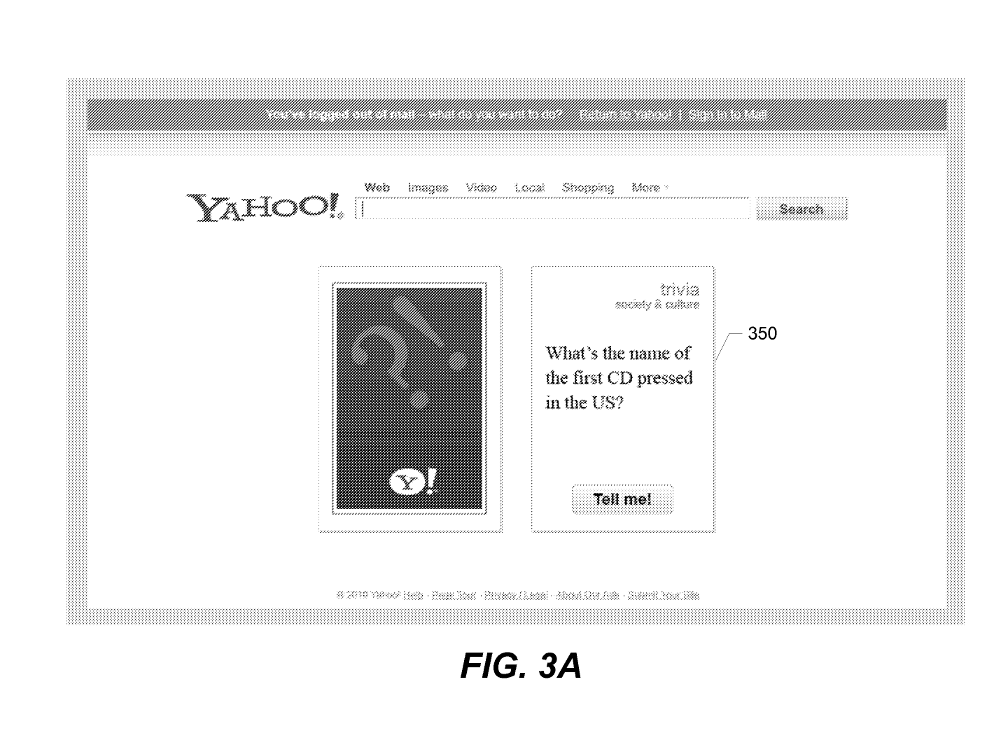

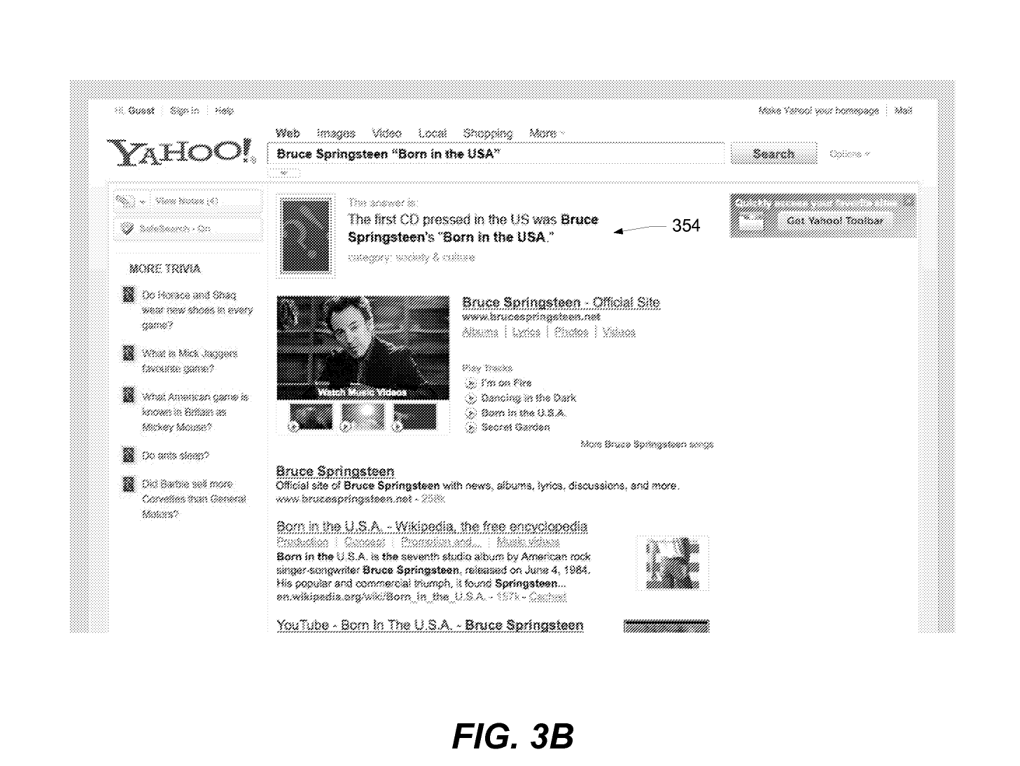

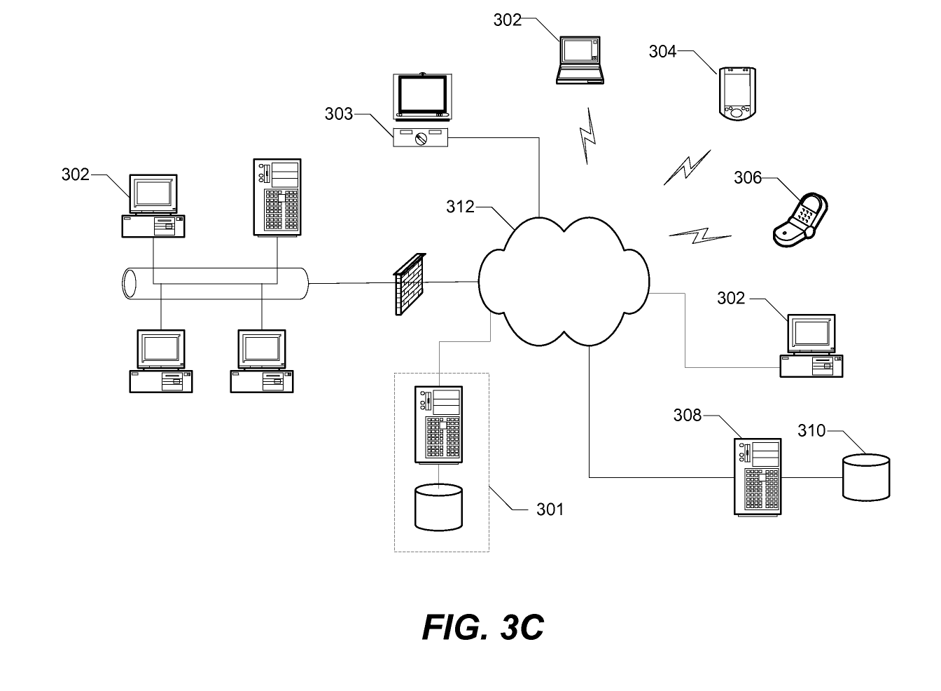

FIG. 2 illustrates a flow chart/architectural model according to an embodiment. In step 208, the system (see e.g. FIG. 3) issues queries to a search engine to find potential sources of seed trivia facts. In step 212 the system generates seed trivia facts from the retrieved web pages by extracting the facts. Embodiments generate candidate facts as an information extraction task and in some cases use bootstrapping extraction methods. Bootstrapping methods for information extraction start with a small set of seed tuples from a given relation. The extraction system finds occurrences of these seed instances in plain text and learns extraction patterns based on the context around these instances, as indicated by step 216. For instance, given a seed instance ‘birds have right of way in Utah’ which occurs in the text, Did you know: Birds have right of way in Utah?, the system learns the pattern, “Did you know: [symbol] f [symbol] ?” Extraction patterns are, in turn, applied to text to identify new instances of the relation at hand, as seen in step 224. The new candidate trivia facts are found in text databases 250, which may for example comprise information from query logs 250A, web crawls 250B, and news articles 250C. For instance, the above pattern when applied to the text, Did you know: A newborn kangaroo is about 1 inch in length? can generate a new instance, ‘A newborn kangaroo is about 1 inch in length.’

The extraction system iterates over the step of learning extraction patterns and applying them for a pre-defined number of iterations. Using this bootstrapping method, an example of patterns that were learned and used to generate the database are:

TABLE 1
Sample patterns learned using bootstrapping;

p₁: Did you know: [symbol] f [symbol]
p₂: Incredible but true, [symbol] f [symbol]
p₃: Interesting fact: [symbol] f

[symbol]

f stands for a trivia fact.

While these patterns effectively capture the context around trivia facts, the resulting output can be fairly noisy. Furthermore, not all candidate facts are equally interesting. To alleviate this problem of demoting uninteresting or unreliable trivia facts, embodiments build and employ a supervised approach for assigning scores to each candidate fact.

### Training an Interestingness Model

The supervised approach involves training an “interestingness” model, as represented by steps 220 and in part step 228. First, in step 220, the system identifies a multitude of features of each fact, each having a numeric value; then it marks these as V=v₁, v₂, . . . , vₙ, where n is the number of different features the system extracts from each fact. Details on the features are given below.

The set of features utilized to represent each fact includes features pertaining to the fact itself, features derived from the sentence it is part of, and features relating to the document it was discovered in. Specifically, embodiments may include the following features in the model:

### Fact-Level Features

Length: The number of words and the log of the byte length of the fact.

“Engaging” terms: The number of terms or phrases, from a predefined set of terms assumed to signal a high interestingness level, that are found within close proximity to the fact (examples of terms in this predefined are words such as “trivia” or phrases like “did you know?”).

Part of speech counts: The number of times each part of speech occurs in the fact (e.g., the number of nouns, verbs, adjectives, and so on).

Noun correlation: The minimum, maximum, and average correlation, as measured using Pointwise Mutual Information over a large corpus, between the nouns in the fact.

Noun-adjective correlation: Similar to the noun-correlation, except that correlation values are measured between noun-adjective pairs.

Query log frequency: The minimum, maximum, and average query frequency of the nouns of the fact in a large-scale web search engine log.

Corpora frequency: The minimum, maximum, and average document frequency of the nouns in the fact in several predefined large collections of documents: a general web corpus, a news document corpus, a financial information corpus, a collection of entertainment articles, and so on.

### Sentence-Level Features

Length: The number of words and the log of the byte length of the sentence.

Position: Whether the sentence occurs in the beginning of the document, end of it, and so on.

### Document-Level Features

Length: The number of words and the log of the byte length of the document.

Domain: The top-level Internet domain of the document (.com, .edu, . . . )

Fact Count: The number of facts identified in the document.

Search engine runtime data: Information derived from access logs of a search engine regarding the page, such as the number of times it was presented to users in search results, the number of times it was clicked, and the ratio between these (the click-through rate).

Search engine index data: Information calculated and stored by the search engine regarding the nature of every observed page: its authority score (e.g., based on incoming link degree or other web page authority estimation techniques such as PageRank); the likelihood that it contains commercial content, adult content, local content, or other types of topical content.

After extracting the feature set V, the system learns a function ƒ(V)→ [symbol] , mapping from this set to a numeric value (that will serve as the interestingness score), as represented by steps 228 and 232. For this, embodiments may utilize one of many well-known approaches for deriving such a function, such as logistic regression. In general, these functions are chosen such that the error between their output and the values of the training set—the set of engaging and non-engaging facts described above—is minimized. The error here is the difference between the output of the function for a specific fact and its assumed engagement level: 1 for a seed of interesting facts, and 0 for the other facts.

Given a candidate fact for which the engagement value needs to be determined, embodiments first compute the values V for the features described earlier. They then apply the mapping function ƒ to these values, and use ƒ(V) as the interestingness score that is assigned to each candidate fact in step 232. Finally, as represented by step 236, the system ranks all candidate facts by their interestingness values, and in certain embodiments selects only those with scores according to the scoring function ƒ that are above a satisfactory threshold.

Additional steps that may be performed at this stage include application of various filters to the extracted facts. For example, the system may remove duplicate facts by computing the pairwise similarity between all facts using a standard similarity measure for text snippets, such as the cosine similarity between the term vectors of the facts, and selecting only one fact (the one with higher engagement) from each pair that has high similarity.

### Identifying Trigger Terms for Trivia Facts

Trigger terms are associated with trivia facts in the database and identification of the terms in various user contexts is used to trigger provision of the correlated trivia. To identify trigger words for trivia facts, the system processes the facts using a text chunker which partitions each fact into segments of connected words. Given a chunk for a fact, the system uses a binary classifier to decide whether the chunk is a promising trigger word for the fact. One embodiment uses a simple binary classification rule based on a popularity score of each term. In this exemplary embodiment, the system computes a tf-idf score for each identified text chunk over a corpus of web pages as well as query logs. The system will eliminate trigger terms with a popularity score below a threshold α. As an additional source, some embodiments may also employ other resources/databases 250 such as Wikipedia and Wordnet to expand the trigger words to include semantically related words.

The embodiments generate and subsequently utilize a database 244 of trivia facts comprising records of the form: [symbol] f, t, s [symbol] where fact f is associated with terms t and has an interestingness score of s.

At runtime, applications such as search engines may probe the database for trigger terms that exist in a user query to identify interesting trivia facts. In case of multiple matching facts a single fact may be randomly selected while influencing the random selection by the interestingness score associated with each fact.

Once a database of terms with related and acceptable trivia is established, it may be utilized in various contexts. In one example, random, engaging trivia facts may be displayed on auto-generated content pages. Such facts may be displayed in any number of ways, such as adding a trivia tab to an automatically or otherwise generated page on a topic. One example environment is shown in FIG. 3A. FIG. 3A illustrates a screen that is shown to a user after it has logged out of an account. A trivia question 350 is presented to a user and when the user clicks the button the answer (trivia fact) 354 will be shown, as seen in FIG. 3B. While an email account is depicted, a trivia fact and/or question may be shown after logoff, logon, or other interaction with an account or page. Another example context involves utilization by a search engine and search provider to produce trivia facts related to a search query propounded by a user. For example, a trivia fact may be produced in response to a query of a search engine and provided with the results, or may be provided together with search assist options.

The above techniques are implemented in a search provider computer system. Such a search engine or provider system may be implemented as part of a larger network, for example, as illustrated in the diagram of FIG. 3C. Implementations are contemplated in which a population of users interacts with a diverse network environment, accesses email and uses search services, via any type of computer (e.g., desktop, laptop, tablet, etc.) 302, media computing platforms 303 (e.g., cable and satellite set top boxes and digital video recorders), mobile computing devices (e.g., PDAs) 304, cell phones 306, or any other type of computing or communication platform. The population of users might include, for example, users of online email and search services such as those provided by Yahoo! Inc. (represented by computing device and associated data store 301).

Regardless of the nature of the search service provider, searches may be processed in accordance with an embodiment of the invention in some centralized manner. This is represented in FIG. 3C by server 308 and data store 310 which, as will be understood, may correspond to multiple distributed devices and data stores. The invention may also be practiced in a wide variety of network environments including, for example, TCP/IP-based networks, telecommunications networks, wireless networks, public networks, private networks, various combinations of these, etc. Such networks, as well as the potentially distributed nature of some implementations, are represented by network 312.

In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer system for fulfilling a search query, the computer system configured to:
generate seed trivia facts;
extract features of the seed facts;
train a supervised model to compute an interestingness score for candidate trivia facts;
use the model to identify new candidate trivia facts;
assign interestingness score to the candidate facts;
rank the candidate trivia facts to create a selected set of trivia facts;
identify trigger terms for each trivia fact of the selected set;
create a database comprising a plurality of trivia entries, each entry comprising: a trivia fact of the selected set; the interestingness score for the trivia fact; and one or more trigger terms for the trivia fact; and
monitor a query made of the computer system and determine if the query contains a trigger term of the one or more trigger terms contained in the database.

2. The computer system of claim 1, wherein the computer system is further configured to prune facts scoring below a threshold value for interestingness before adding them to the database.

3. The computer system of claim 1, wherein the computer system is further configured to extract fact level features for the seed facts and the candidate facts.

4. The computer system of claim 1, wherein the computer system is further configured to extract sentence level features for the seed facts and the candidate facts.

5. The computer system of claim 1, wherein the computer system is further configured to extract document level features for the seed facts and the candidate facts.

6. The computer system of claim 1, wherein the computer system is further configured to generate the seed trivia facts and/or extract features of trivia facts from query logs.

7. The computer system of claim 1, wherein the computer system is further configured to generate the seed trivia facts and/or extract features of trivia facts by performing or referencing web crawls.

8. The computer system of claim 1, wherein the computer system is further configured to generate the seed trivia facts and/or extract features of trivia facts from news articles.

9. The computer system of claim 1, wherein the computer system is further configured to provide a trivia fact from the database in response to a query found to contain a trigger term.

10. The computer system of claim 9, wherein the computer system is further configured to provide the trivia fact in conjunction with search assist suggestions.

11. A method for operating a search engine system, the method comprising:
generating seed trivia facts;
extracting features of the seed facts;
training a supervised model to compute an interestingness score for candidate trivia facts;
using the model to identify new candidate trivia facts;
assigning interestingness score to the candidate facts;
ranking the candidate trivia facts to create a selected set of trivia facts;
identifying trigger terms for each trivia fact of the selected set;
creating a database comprising a plurality of trivia entries, each entry comprising: a trivia fact of the selected set; the interestingness score for the trivia fact; and one or more trigger terms for the trivia fact; and
monitoring a query made of the computer system and determine if the query contains a trigger term of the one or more trigger terms contained in the database.

12. The method of claim 11, wherein the method further comprises eliminating facts scoring below a threshold value for interestingness before adding facts to the database.

13. The method of claim 11, wherein the method further comprises extracting fact level features for the seed facts and the candidate facts.

14. The method of claim 11, wherein the method further comprises extracting sentence level features for the seed facts and the candidate facts.

15. The method of claim 11, wherein the method further comprises extracting document level features for the seed facts and the candidate facts.

16. The method of claim 11, wherein the method further comprises generating the seed trivia facts and/or extracting features of trivia facts from query logs.

17. The method of claim 11, wherein the method further comprises generating the seed trivia facts and/or extracting features of trivia facts by performing or referencing web crawls.

18. The method of claim 11, wherein the method further comprises providing a trivia fact from the database in response to a query found to contain a trigger term.

19. The method of claim 18, wherein the method further comprises providing the trivia fact in conjunction with search assist suggestions.

20. A computer system for providing a service to a user, the computer system configured to:
generate seed trivia facts;
extract features of the seed facts;
train a supervised model to compute an interestingness score for candidate trivia facts;
use the model to identify new candidate trivia facts;
assign interestingness score to the candidate facts;
rank the candidate trivia facts to create a selected set of trivia facts; and
identify trigger terms for each trivia fact of the selected set.
